(19) United States
(12) Patent Application Publication
(10) Pub. No.: US 2012/0066081 A1
(43) Pub. Date: Mar. 15, 2012

(54) PAYMENT SYSTEM TO FACILITATE TRANSACTIONS

(76) Inventors: Daniel Jeffrey Shader, Palo Alto, CA (US); John Paul Minor, Brick, NJ (US); Richard Scott Perkins, Meridian, ID (US); Marc-André Lamarche, Lorraine (CA); Jean-Sébastien Boulanger, Boucherville (CA)

(21) Appl. No.: 13/298,179

(22) Filed: Nov. 16, 2011

Related U.S. Application Data
(63) Continuation of application No. 13/087,271, filed on Apr. 14, 2011.
Application No. 13/087,271 is a continuation-in-part of application No. 13/123,067, filed on May 11, 2011.
(60) Provisional application No. 61/136,830, filed on Oct. 7, 2008.

(51) Int. Cl. G06Q 20/40

(52) U.S. Cl. 705/18

(57) ABSTRACT

Disclosed herein are systems and method for facilitating transactions between a merchant-partner and a customer. In general, the systems and methods include: (a) staging a transaction between the merchant-partner and the customer; (b) tokenizing the transaction by linking one or more transaction instructions to a token ID; (c) providing the customer with the token ID, wherein the customer can then present the token ID and a payment to a point-of-sale terminal; (d) receiving confirmation that the customer has presented, to a point-of-sale terminal, the token ID and a payment in accordance with the one or more transaction instructions; (e) notifying the merchant-partner that the customer provided the payment to the point-of-sale terminal; and (f) settling the transaction between the point-of-sale terminal and the merchant-partner.

### CROSS-REFERENCE TO RELATED APPLICATION

This application is a continuation of U.S. patent application Ser. No. 13/087,271, filed Apr. 14, 2011; which is a continuation-in-part of U.S. patent application Ser. No. 13/123,067, filed May 11, 2011; which is a U.S. National Phase of PCT/CA2009/001406, with an international filing date of Oct. 5, 2009; and which claims the benefit of priority to U.S. Provisional Application No. 61/136,830, filed Oct. 7, 2008, the disclosures of which are all incorporated herein by reference in their entirety.

### TECHNICAL FIELD

The present invention relates to a reverse payment transaction system and method.

### BACKGROUND

Commonly, a wide range of payment methods are available to consumers of goods and services: credit cards, debit cards, checks, cash, prepaid cards, and others. Most of those payment methods require the consumer to transmit either financial information or a negotiable instrument to a merchant (or a payment processor chosen by the merchant). The merchant usually uses the consumer's financial information to debit the amount of the payment from its bank account, credit card margin, or other. These payment methods are comprehensive for the consumer when he can trust the merchant and the channel over which his financial details are transferred (e.g. in person).

The advent of e-commerce over global information networks (the Internet) has facilitated commerce between consumers and merchants located all around the world, hence requiring the transfer of payments between parties located far apart, possibly in different legislations. As of today, the payment methods that are mostly used in e-commerce are adaptations of the same traditional payment methods that require the disclosure of consumers financial information (credit cards, checks).

A problem arise in that these payment methods require the consumer to transmit financial information to an untrusted party (a merchant or payment processor located far away, possibly in a different legislation) and/or over an untrusted channel (the Internet) to complete the payment. Even with the advancement of encryption technologies such as public-key cryptography, many consumers are still not ready to take the risk of transmitting sensitive information over the Internet.

Other solutions exist such as e-cash or prepaid cards where the consumer does not have to disclose information over the Internet, but those still require transmitting a negotiable instrument to an untrusted party or over an untrusted channel. Other solutions provide an e-wallet (e.g. Paypal™) but they are usually linked to a real bank account and require the consumer to subscribe to the service (and provide personal information).

In the global economy, there is the need for a payment method that saves the consumer from revealing any financial information to untrusted parties or over an untrusted channel such as the Internet. There is also a need for unbanked or underbanked consumers who do not have bank accounts and credit cards to perform payment without the exchange of negotiable instruments over the untrusted Internet.

Recent studies estimate that there may be as many as 80 million U.S. consumers, representing a collective buying power of over $1 trillion annually, without access to traditional bank accounts or credit cards. For example, an estimated 25% of U.S. households, and 15% of teenagers, do not have access to credit cards. Additionally, an estimated 75% of consumers with access to credit cards do not use their credit cards. These estimates indicate that there is a large population of consumers that are limited to cash transactions and/or traditional pre-paid instruments, such as general purpose reloadable (GPR) cards or closed-loop cards. Merchants (particularly web-based or catalog-based merchants) wishing to target such consumers, may be well served by systems and methods that provide easier, faster, and more secure alternatives to cash transactions and/or traditional pre-paid instruments.

### SUMMARY

Disclosed herein are systems and method for facilitating transactions between a merchant-partner and a customer. In one embodiment, a service provider and/or point-of-sale (POS) terminal serves as an intermediary between a merchant-partner and the customer. The system allows the customer to pay for the merchant-partner's goods/services in cash (or cash equivalents) at a POS terminal. The POS terminal and/or service provider then notifies the merchant that the customer has made a payment. After the merchant-partner has received a notification, validation, or otherwise confirmation of payment, the merchant-partner can securely complete the agreed upon transaction between the merchant-partner and the customer.

However, in order for such system to be commercially viable, certain process steps are included. For example, the systems and methods presented generally include: (a) staging a transaction between the merchant and the customer; (b) tokenizing the transaction by linking one or more transaction instructions to a token ID; (c) providing the customer with the token ID, wherein the customer can then present the token ID and a payment to a POS terminal; (d) receiving confirmation that the customer has presented, to the POS terminal, the token ID and a payment in accordance with the one or more transaction instructions; (e) notifying the merchant that the customer provided the payment to the POS terminal; and (f) settling the transaction between the POS terminal and the merchant. Embodiments of process steps (a)-(f) are described in more detail below.

Aspects of the present invention are particularly useful in providing merchants (e.g., web-based or catalog-based merchants) with a means for conducting fast, easy, and secure transactions with consumers. The present invention is also particularly useful in facilitating transactions such as: loan repayments, collections, money transfers, bill payments, remote deposits, etc.

### BRIEF DESCRIPTION OF THE FIGURES

The accompanying drawings, which are incorporated herein, form part of the specification. Together with this written description, the drawings further serve to explain the principles of, and to enable a person skilled in the relevant art(s), to make and use the claimed systems and methods.

FIG. 1 is a schematic view of the reverse payment transaction system according to an illustrative embodiment of the present invention;

FIG. 2 is a flow diagram depicting the reverse payment transaction method according to an illustrative embodiment of the present invention;

FIG. 3 is a flow diagram depicting an illustrative example of the merchant subscription process;

FIG. 4 is a flow diagram depicting an illustrative example of the invoice registration process;

FIG. 5 is a flow diagram depicting an illustrative example of the invoice payment process;

FIGS. 6A and 6B is a flow diagram depicting an illustrative example of the invoice registration process with external offerings;

FIG. 7 is a flow diagram depicting an illustrative example of the optional insurance process; and

FIG. 8 is a flow diagram depicting an illustrative example of the merchant invoice registration process.

FIG. 9 is a high-level flow process chart illustrating the relationships between the parties that partake in the presented systems and methods.

FIG. 10 is a high-level flowchart illustrating a method for facilitating transactions, in accordance with one embodiment presented herein.

FIG. 11 is a flowchart illustrating an aspect of the method of FIG. 10.

FIG. 12 is a flowchart illustrating an aspect of the method of FIG. 10.

FIG. 13 is a flowchart illustrating an aspect of the method of FIG. 10.

FIG. 14 is a flowchart illustrating an aspect of the method of FIG. 10.

FIG. 15 is a flowchart illustrating an aspect of the method of FIG. 10.

FIG. 16 is a schematic drawing of a computer system used to implement the methods presented herein.

### DETAILED DESCRIPTION

Generally stated, the non-limitative illustrative embodiment of the present invention provides a reverse payment transaction system and method in which the consumer, rather than disclosing his financial details, acquires a unique reference code associated with a bill registered by the merchant in a payment processor database. The consumer than acquits the payment through a trusted channel of choice.

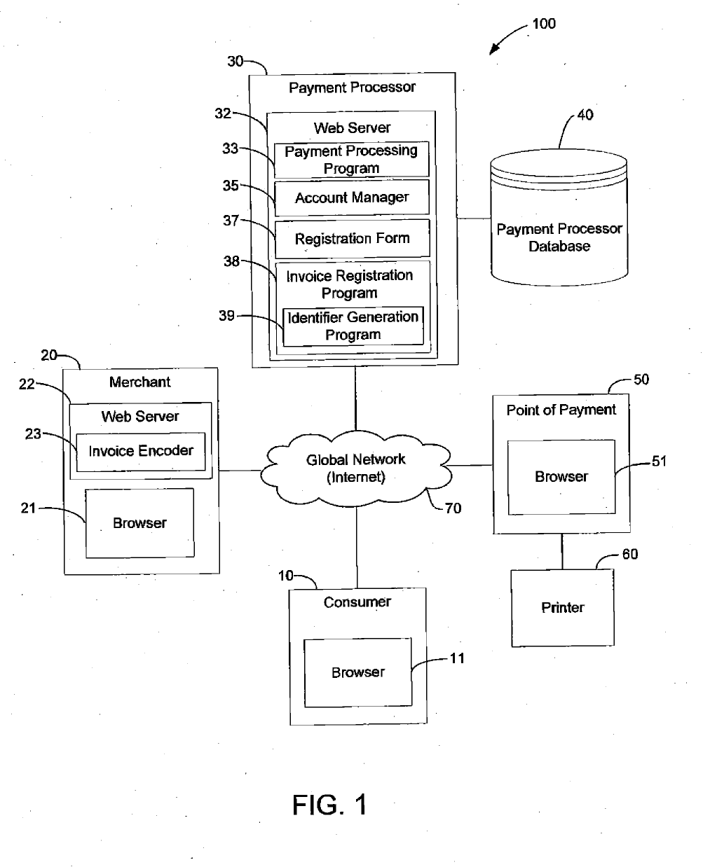

Referring to FIG. 1, there is shown a reverse payment transaction system 100 in which a consumer using a communication device 10 such as a personal computer, a laptop computer, personal assistant device, mobile phone or any other such computing device, on which can run a user interface in the form of a communication software, such as a web browser 11 or other such software, may access a merchant system 20 having a web server 22 providing e-commerce functionalities via an Internet connection 70, for example Ethernet (broadband, high-speed), wireless WiFi, cable Internet, satellite connection, cellular or satellite network, etc.

The merchant system 20 can also be a subsystem of a larger system. Furthermore, the term “merchant” is not meant to be limited to the operators of e-commerce websites, it can also include, for example, product and service providers such as banks.

The merchant web server 22 includes an invoice encoder 23 that can encode invoices in a pre-determined format. Part of the invoice encoder 23 can be provided by a reverse payment processor system 30 and linked to a cryptographic library. The merchant system 20 also includes a user interface in the form of communication software, such as a web browser 21, to access the reverse payment processor system 30 in order to register or manage its account.

The reverse payment processor system 30 includes a web server 32 that hosts an invoice registration program 38 for registering invoices generated by the invoice encoder 23 of the merchant system 20 when a consumer makes a purchase through the merchant web server 22. An identifier generation program 31 generates unique identifiers for invoices registered by the invoice registration program 38 using, for example, a pseudo random number generation algorithm. The reverse payment processor system 30 also includes a payment processing program 33 which allows the retrieval of invoices information and execute payment, a merchant account management program 35 and a registration form 37 to allow merchant systems 20 to create an account with the reverse payment processor system 30 and manage their account. Through the merchant account management program 35, the merchant may change account parameters, list pending and completed payments, cancel pending transactions, etc.

A payment processor database 40, such as a relational database package, stores all of the invoices registered by the invoice registration program 38 along with their unique identifiers generated by the identifier generation program 31.

A point-of-payment device 50 may take the form of, for example, a personal computer, a laptop computer or any other such computing device disposed at a point-of-sale (POS), or a mobile phone, personal assistant device or any other such communication device. The point-of-payment device 50 includes a user interface in the form of communication software, such as a web browser 51, POS software, pluggin or other such software to provide communication with the reverse payment processor system 30 via, for example, the Internet connection 70. In an alternative embodiment, the point-of-payment device 50 may be connected to the reverse payment processor system 30 through a closed proprietary network. The point-of-payment device 50 can also be connected to a printer 60 to be used to print receipts of payment.

### Reverse Payment

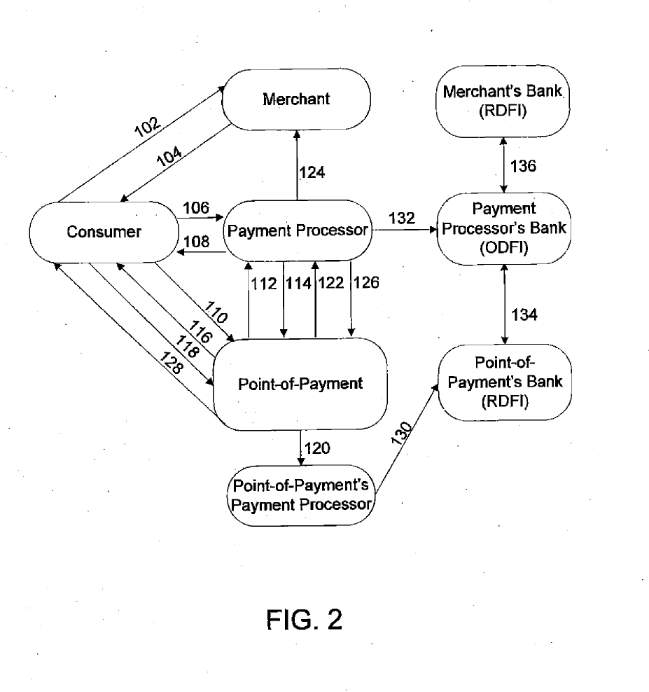

Referring now to FIG. 2, there is shown a diagram of an illustrative embodiment of the reverse payment process 100 describing, with references to FIG. 1, the exchange of information and money between the different parties during a transaction, which are indicated by links 102 to 136.

The process 100 starts at link 102 where a consumer, using a communication device 10, accesses the merchant system 20 web server 22, browses the merchant's list of offered products or services and selects a product or service to purchase.

Then, at link 104, the invoice encoder 23 of the merchant system 20 provides encoded payment information (amount, merchant ID, currency, merchant purchase/transaction identifier, terms and conditions of the sale, etc.) to the consumer communication device 10.

At link 106, the consumer communication device 10 provides the payment information to the invoice registration program 38 of the reverse payment processor system 30, which stores that information in the payment processor database 40, and generates, through the identifier generation program 31, a unique payment identifier (PID) associated with the payment for that transaction. The generated PID is then saved in the payment processor database 40.

Then, at link 108, the reverse payment processor system 30 transmits the PID to the consumer communication device 10. Optionally, the reverse payment processor system 30 may propose POS locations to the consumer based, for example, on his or her billing address/postal code, shipping address/postal code or using an IP geolocation database.

At link 110, the consumer caries the PID to a POS with a point-of-payment device 50 and hands in the PID to the clerk. The clerk enters the PID into the point-of-payment device 50. Alternatively, the point-of-payment device 50 may be a self serve terminal similar to an automated teller machine where the consumer may transfer funds directly from a bank account, use a credit card or through another such means. The point-of-payment device 50 may also be a personal device such as a personal computer or a mobile phone that connects to the web interface of a bank account (i.e., on-line bill payment) or of another payment provider.

At link 112, the point-of-payment device 50 transmits the PID to the payment processing program 33 of the reverse payment processor system 30 and requests the payment details such as the amount and the currency.

At link 114, the reverse payment processor system 30 provides the payment information associated with the PID to the point-of-payment device 50.

Then, at link 116, the clerk charges the consumer for the payment's specified amount. The clerk may also confirm other payment details with the consumer such as the merchant purchase/transaction identifier.

Following which, at link 118, the consumer pays the requested amount by cash or using another payment method accepted by the point-of-payment device 50.

At link 120, the point-of-payment device 50 processes the payment in cash or through a partner payment processor for credit cards, debit cards, or other such payment means. It is to be understood that the partner payment processor may be optional in cases where the point-of-payment device 50 is associated with a bank or other financial services provider that can process credit cards, debit cards and other such payment means.

Then, at link 122, the point-of-payment device 50 notifies the payment processor 30 that the consumer's payment has been processed. It is to be understood that the notification may be performed through a third party system or service such as, for example, an email system integrated with the merchant system 20.

At link 124, the merchant system 20 is notified that the payment has been processed and the amount now appears in the merchant's account. At this time, the merchant may fulfill the consumer's purchase.

At link 126, the reverse payment processor system 30 provides a transaction confirmation identifier (TID) to the point-of-payment device 50. The TID can be used by the consumer has a proof of payment.

Then, at link 128, the point-of-payment device 50 prints for the consumer, using printer 60, a receipt on which appear the TID and the amount paid.

At link 130, either at the end of the day, at predetermined time intervals or at other selected times, the point-of-payment device 50 deposits the consumer payment into the point-of-payment's bank account.

At link 132, once the reverse payment processor system 30 has confirmation that the point-of-payment device 50 has deposited the payment in its bank account (or after a predetermined time period), it debits the point-of-payment's bank account through, for example, an automated clearing house (ACH) network or an e-wallet.

At link 134, either at the end of the month, at predetermined time intervals or at other selected times, if the amount was not already subtracted from the payments collected from the point-of-payment devices 50, the reverse payment processor system 30 pays the commissions due to its point-of-payment partners through, for example an ACH network. This step may vary depending on the business agreement with the point-of-payment partner.

Finally, at link 136, the merchant's money may rest in a “reverse payment” account until he/she requests it to be transferred to its bank account. When the merchant is ready to transfer the money, the reverse payment processor system 30 performs the transfer through, for example, an ACH network.

### Merchant Subscription

The merchant subscription process consists in the merchant enrolling with the reverse payment processor system 30 in order to start accepting payment through the reverse payment transaction system 100 shown in FIG. 1.

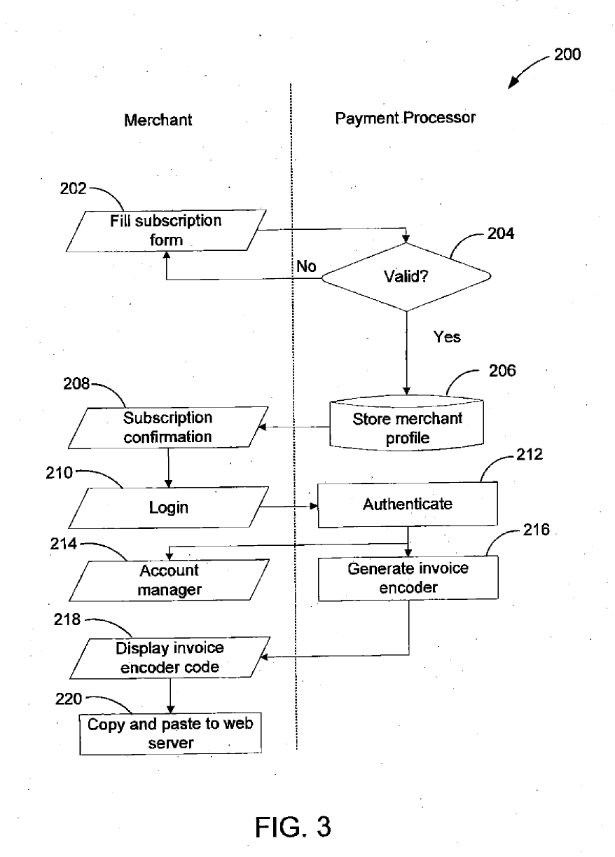

Referring to FIG. 3, there is shown a flow diagram of an illustrative example of the merchant subscription process 200. Steps of the process 200 are indicated by blocks 202 to 220.

The process 200 starts at block 202 where the merchant fills a registration form 37 on the web server 32 of the reverse payment processor system 30 using, for example, the web browser 21 of the merchant system 20.

Then, at block 204, the reverse payment processor system 30 verifies if the form is valid, i.e. that all of the required profile information has been entered (and optionally, performing some validation of the submitted information). If so, the process 200 proceeds to block 206, otherwise it returns to block 202.

At block 206, the reverse payment processor system 30 stores the merchant's profile information in the payment processor database 40. The reverse payment processor system 30 then sends, at block 208, a subscription confirmation to the merchant system 20.

At block 210, the merchant may login into the merchant account manager 35 through the web server 32 of the reverse payment processor system 30 and, at block 212, authenticate his or her account. The merchant may then, at block 214, manage his or her account.

Following a first login into the reverse payment processor system 30, an invoice encoder 23 is generated, at block 216, by the reverse payment processor system 30 and then its code displayed, at block 218, through the web browser 21 of the merchant system 20 so as to allow, at block 220, the merchant to copy and paste the invoice encoder 23 code into the merchant web server 22. The invoice encoder 23 may take the form of a “widget” consisting of HTML and Javascript code, embedded flash, or other component executed directly on the merchant web server 22.

### Invoice Registration

The invoice registration process is performed when a consumer, using the consumer communication device 10, makes a purchase on the merchant system 20 and selects the reverse payment option which is supported by the reverse payment transaction system 100 shown in FIG. 1. This process consists in registering the payment information (e.g. amount, currency, product or service, etc.) in the payment processor database 40 such that it can be paid at a later time.

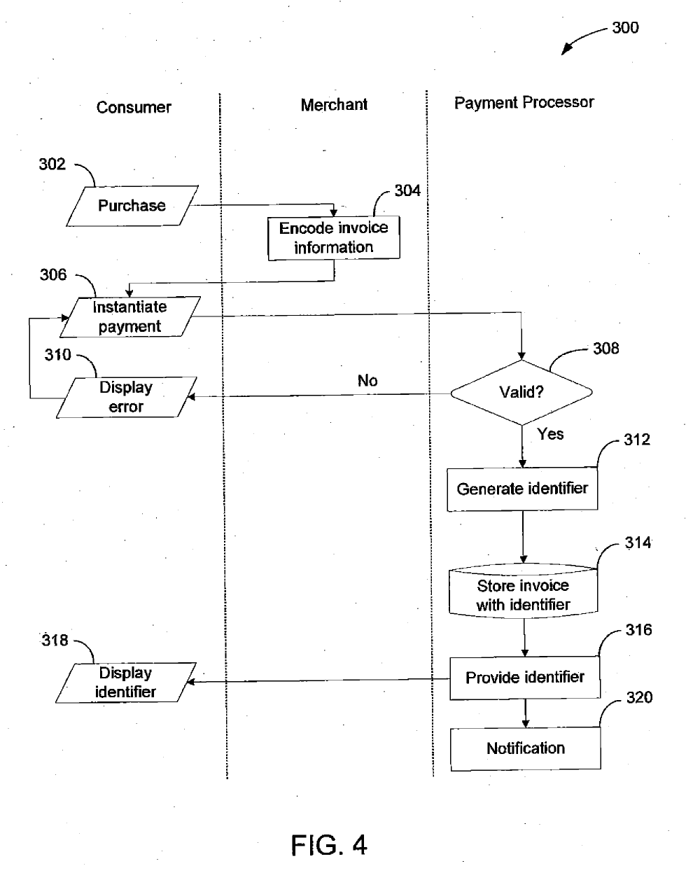

Referring to FIG. 4, there is shown a flow diagram of an illustrative example of the invoice registration process 300. Steps of the process 300 are indicated by blocks 302 to 320.

The process 300 starts at block 302 where a consumer browses web pages on the merchant web server 22 and makes a purchase through the usual website checkout process. This consists in HTTP requests between the consumer's web browser 11 and the merchant's web server 22.

At block 304, when requesting the last page of the checkout process, the payment page, the merchant web server 22 encodes, using the invoice encoder 23, the purchase invoice information (e.g. product or service unique identifier, amount due, currency, etc.) as well as its merchant identifier in a special pre-defined format. This information may be encoded as parameters of a URL to the invoice registration program 38 on the web server 32 of the reverse payment processor system 30. The invoice information may also be encrypted or digitally signed to enhance security. This information is encoded in the payment page in the form of a clickable link, button, image, or widget.

Then, at block 306, the consumer instantiates the registration of the invoice with the invoice registration program 38. In some cases this is done explicitly by the consumer by clicking on the link, button, image, or widget on the payment page on the web server 22 of the merchant system 20. In other cases it may be performed automatically by the web browser 11 of the consumer communication device 10. The web browser 11 then transmits the encoded invoice information to the invoice registration program 38.

At block 308, the invoice registration program 38 decodes the encoded invoice and validates the invoice information (e.g. the amount is positive, the currency is accepted, etc.). In some cases the invoice registration program 38 may also run fraud prevention algorithms to prevent abuses of the reverse payment processor system 30. If the invoice information is not valid, the process 300 displays, at block 310, an error message to the consumer and then returns to block 306. The process 300 may also send a notification of the error to the merchant system 20 through, for example, email, SMS, or other means.

If the invoice information is valid, the process 300 proceeds to block 312 where the PID is generated by the identifier generation program 31 and associated with the invoice. In some embodiment the PID can be unique for the lifetime of the system, in others, for a finite period of time such that the PID may be reused. A pseudo-random algorithm may be used to generate or select the identifier.

Then, at block 314, the invoice information along with the PID are stored in the payment processor database 40. The invoice is then marked as pending (i.e. not paid).

At block 316, the PID is provided to the web browser 11 of the consumer communication device 10 for display following which, at block 318, the PID is displayed to the consumer. The PID can then be copied/pasted, printed, or sent to an email box, a mobile phone, or otherwise recorded.

Finally, at block 320, the invoice registration program 38 may send further notification of the registered pending invoice (e.g. to the merchant system 20).

### Invoice Payment

The invoice payment process is performed when a consumer pays an invoice at a point-of-payment device 50 (e.g. at a brick-and-mortar store) through the reverse payment transaction system 100 shown in FIG. 1. The payment is taken from the consumer at the point-of-payment device 50 on behalf of the reverse payment processor system 30. The point-of-payment device 50 notifies the reverse payment processor system 30 that the payment was made, and in turn the reverse payment processor system 30 can notify the merchant system 20.

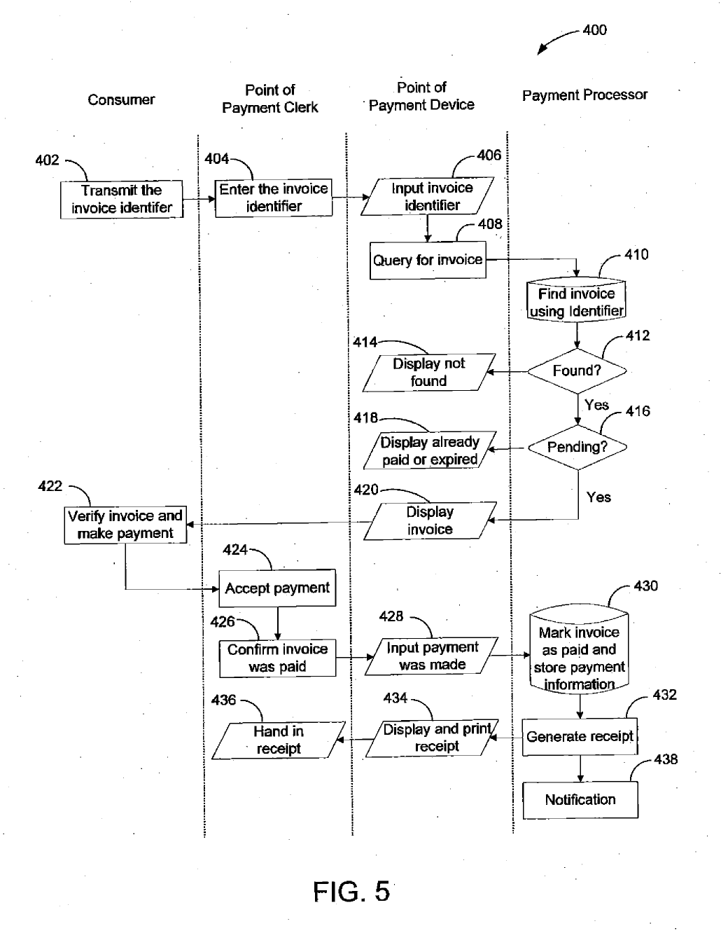

Referring to FIG. 5, there is shown a flow diagram of an illustrative example of the invoice payment process 400. Steps of the process 400 are indicated by blocks 402 to 438.

The process 400 starts at block 402 where the consumer transmits the PID to the clerk (i.e. the person operating the point-of-payment device 50). The transmission can be done orally, with a piece of paper, barcode, or by some electronic transmission mode such as, for example, radio-frequency identification (RFID), Bluetooth or a communication network such as the Internet, supported by both parties.

At block 404, the clerk enters the PID using, for example, a keyboard, a barcode reader, a RFID reader or a Bluetooth interface, which is inputted, at block 406, into the point-of-payment device 50.

At block 408, the point-of-payment device 50 transmits a query with the PID to the payment processing program 33, which, at block 410, retrieves the invoice from the payment processor database 40 using the supplied PID.

Then, at block 412, if the invoice is not found a “not found” message is provided, at block 414, to the point-of-payment device 50 and is displayed to the consumer. If the invoice is found, the payment processing program 33 verifies, at block 416, that the invoice is still pending. In particular, the payment processing program 33 verifies that the invoice has not been paid or has expired. If the invoice has already been paid or has expired, a message is provided, at block 418, to the point-of-payment device 50 and displayed to the consumer.

If the invoice has not been paid, the invoice information (e.g. amount due, currency, purchased product or service identifier, merchant name, etc.) is provided, at block 420, and displayed on the point-of-payment device 50.

At block 422, the consumer confirms the invoice information with the point-of-payment clerk and makes the payment (e.g. in cash, debit card, credit card, or other) to the clerk. The clerk then accepts, at block 424, the payment in cash or by any other suitable payment mean or method.

Following this, at block 426, the clerk inputs in the point-of-payment device 50 that the invoice was paid. It should be noted that at any time the clerk may also cancel the current transaction, for example in cases where the consumer decides not to pay, does not have sufficient funds, or for any other reason. Furthermore, the clerk may also perform verifications about the consumer such as, for example, the consumer's age in cases where the consumer must be at least 18 years old.

At block 428, the point-of-payment device 50 transmits the information to the payment processing program 33 that the payment was received for this invoice and, at block 430, information relative to the payment of the invoice such as the point-of-payment device 50 used for payment and the date and time is stored in the payment processor database 40. The invoice is then marked as paid in the payment processor database 40. At this step other records may also be generated for later audits.

At block 432, a receipt is generated from the payment information by the payment processing program 33 and transmitted to the point-of-payment device 50 as a confirmation of the payment.

The receipt is then displayed, at block 434, on the point-of-payment device 50 and may also be printed on the printer 60.

If the receipt is printed, it is then handed over, at block 436, to the consumer. Alternatively, the receipt may also be transmitted electronically.

Finally, at block 438, notification that the invoice was paid may be sent electronically to the merchant system 20 (e.g. through email or other such communication means).

Invoice Registration Process with External Offerings

The invoice registration process with external offerings is an alternative embodiment of the invoice registration process 300 shown in FIG. 4. In this embodiment, when the consumer makes a purchase on the merchant system 30, additional purchase offerings can be made to the consumer at the time of payment. One such additional purchase offering is insurance on the product or service being bought by the consumer. However, the process equally applies to other offerings and as such will be described in general terms.

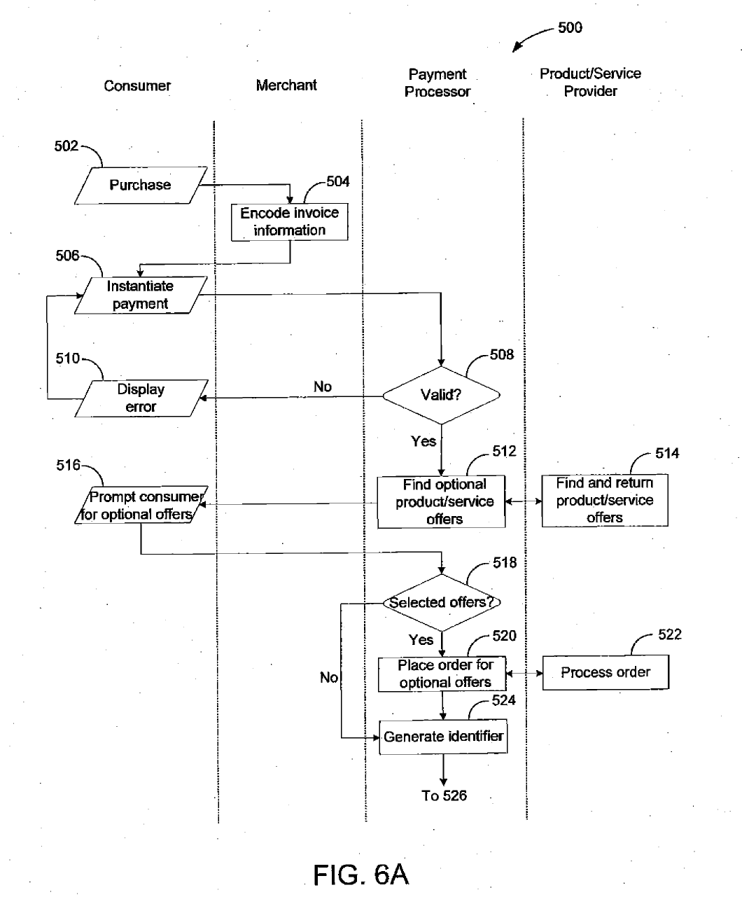

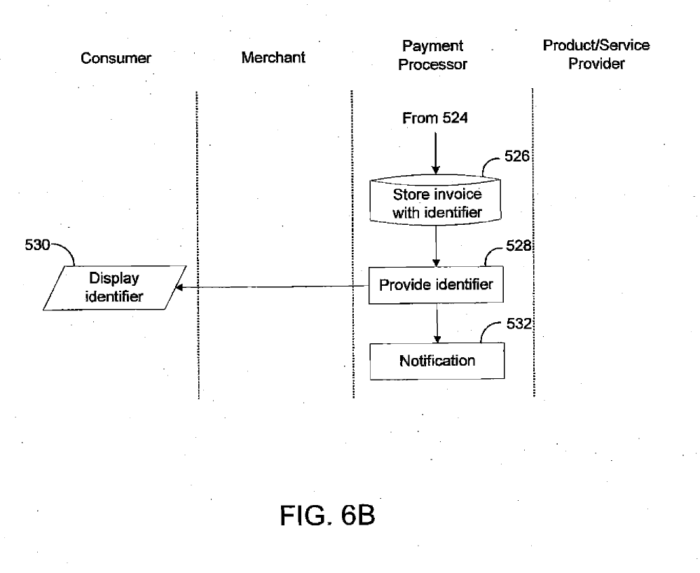

Referring to FIGS. 6A and 6B, there is shown a flow diagram of an illustrative example of the invoice registration with external offerings process 500. Steps of the process 500 are indicated by blocks 502 to 532.

The process 500 starts at block 502 where a consumer browses web pages on the merchant web server 22 and makes a purchase through the usual website checkout process. This consists in HTTP requests between the consumer's web browser 11 and the merchant's web server 22.

At block 504, when requesting the last page of the checkout process, the payment page, the merchant web server 22 encodes, using the invoice encoder 23, the purchase invoice information (e.g. product or service unique identifier, amount due, currency, etc.) as well as its merchant identifier in a special pre-defined format. This information may be encoded as parameters of a URL to the invoice registration program 38 on the web server 32 of the reverse payment processor system 30. The invoice information may also be encrypted or digitally signed to enhance security. This information is encoded in the payment page in the form of a clickable link, button, image, or widget.

Then, at block 506, the consumer instantiates the registration of the invoice with the invoice registration program 38. In some cases this is done explicitly by the consumer by clicking on the link, button, image, or widget on the payment page on the web server 22 of the merchant system 20. In other cases it may be performed automatically by the web browser 11 of the consumer communication device 10. The web browser 11 then transmits the encoded invoice information to the invoice registration program 38.

At block 508, the invoice registration program 38 decodes the encoded invoice and validates the invoice information (e.g. the amount is positive, the currency is accepted, etc.). In some cases the invoice registration program 38 may also run fraud prevention algorithms to prevent abuses of the reverse payment processor system 30. If the invoice information is not valid, the process 500 displays, at block 510, an error message to the consumer and then returns to block 506. The process 500 may also send a notification of the error to the merchant system 20 through, for example, email, SMS, or other means.

If the invoice information is valid, the process 500 proceeds to block 512 where the invoice registration program 38 uses the description of the purchased product or service to find other relevant product or service offerings to be optionally suggested to the consumer. An example of a relevant product may be, for example, optional insurance offered to the consumer to insure its payment and purchase. The external products or services that are offered can be configured in the reverse payment processor system 30 by the merchant using the account manager 35. The optional offerings can also be retrieved, at block 514, from an external provider's system or database (e.g. through a web service).

At block 516, the consumer is prompted with the product or service offers and has the option to add them to the invoice or not and then, at block 518, the invoice registration program 38 determines if optional offerings have been selected for purchase by the consumer.

If the consumer has chosen one of the optional offerings the invoice registration program 38 adds the offering to the invoice and places, at block 520, the order with the external provider. The external provider then processes, at block 522, the order of the consumer. The process 500 then proceeds to block 524.

At block 524, the PID is generated by the identifier generation program 31 and associated with the invoice. In some embodiment the PID can be unique for the lifetime of the system, in others, for a finite period of time such that the PID may be reused. A pseudo-random algorithm may be used to generate or select the identifier.

Then, at block 526, the invoice information along with the PID are stored in the payment processor database 40. The invoice is then marked as pending (i.e. not paid).

At block 528, the PID is provided to the web browser 11 of the consumer communication device 10 for display following which, at block 530, the PID is displayed to the consumer. The PID can then be copied/pasted, printed, or sent to an email box, a mobile phone, or otherwise recorded.

Finally, at block 532, the invoice registration program 38 may send further notification of the registered pending invoice (e.g. to the merchant system 20).

### Optional Insurance

The optional insurance process describes a method through which optional insurance premiums can be offered to consumers having purchased a product or service from a merchant system 20. The method consists of a merchant's requesting a real-time quote from an insurance broker for the purchased product or service. The consumer has the choice to purchase the insurance policy or not. The merchant could also choose to purchase the insurance for the consumer. The insurance policy is purchased from an insurance broker by the merchant on behalf of the consumer. In contrast with the invoice registration with external offerings process 500, the optional insurance process is independent of the payment provider and method used.

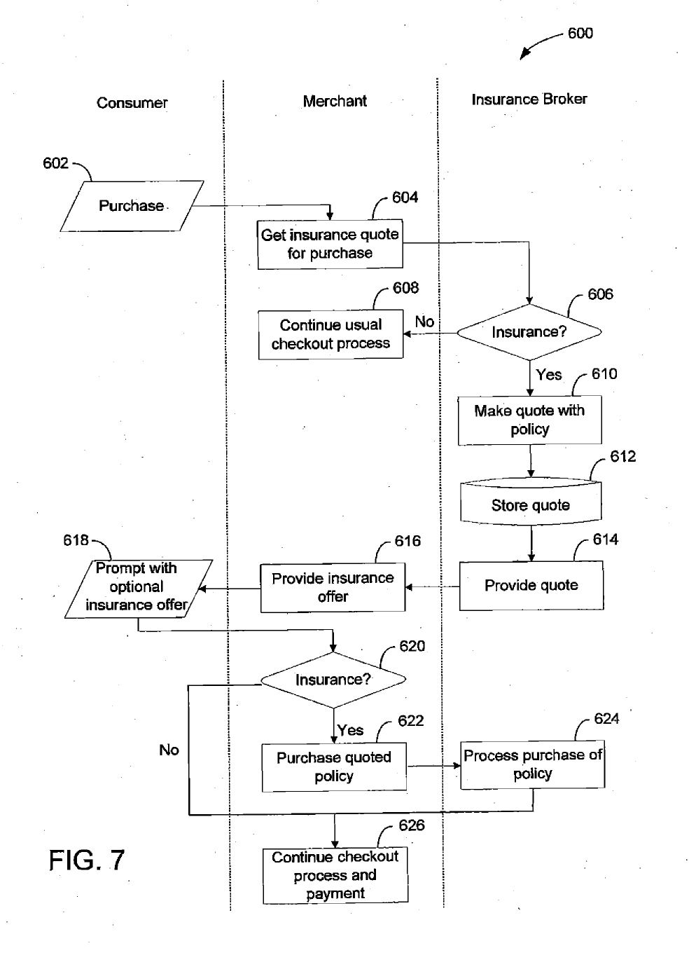

Referring to FIG. 7, there is shown a flow diagram of an illustrative example of the optional insurance process 600. Steps of the process 600 are indicated by blocks 602 to 626.

Process 600 starts block 602 where a consumer, using a communication device 10, accesses the merchant system 20 web server 22, browses the merchant's list of offered products or services and selects a product or service to purchase through the usual checkout process.

During the checkout process, at block 604, while generating one of the check out web pages, the web server 32 of the merchant system 20 requests a policy quote from an insurance broker. The information required by the insurance broker to make a policy quote (e.g. product or service unique identifier, consumer address, currency, etc.) may be encoded by the web server 32 into an HTTP request to a web service. Alternatively, the information may be sent over a secure channel.

Upon receipt of a policy quote request, at block 606, the insurance broker service decides, based on the information provided by the merchant system 20, if the purchased product or service is insurable. Insurance policy for a merchant's product or service would be pre-determined at the time the merchant's registration for the service with the insurance broker.

If the product or service is not insurable, the reason for this is provided, at block 608, to the web server 32 of the merchant system 20, which then continues its usual checkout process.

If the product or service is insurable, the insurance broker dynamically prepares, at block 610, a policy and a premium quote for the product or service to be insured. Both are prepared in real-time based on the pre-entered configuration and on possible variable parameters.

At block 612, the quote is stored in a database of the insurance broker and is assigned a unique identifier.

At block 614, the quote information is provided to the web server 32 of the merchant system 20 including the quote identifier, the premium and links to the details of the policy. The information may be sent, for example, in a XML encoding.

Then, at block 616, the web server 32 of the merchant system 20 extracts the quote information and integrates it into the check out web page of block 604 that is provided to the web browser 11 of the consumer communication device 10. The checkout web page allows the consumer, at block 618, to accept or not refuse the insurance policy offer and provide all the premium information including links to the policy's details.

Following this, at block 618, the web server 32 of the merchant system 20 determines if the consumer decided to accept or refuse the insurance policy offer.

If the consumer decided to accept the insurance policy offer, the web server 32 of the merchant system 20 transmits, at block 622, a purchase request to the insurance broker, which includes the quote identification number and possibly additional information encoded into a HTTP request to the insurance broker web service.

Then, at block 624, the policy purchase request is processed by the insurance broker and, once the purchase of the insurance policy has been completed (or if the consumer decided not to purchase the insurance) the web server 32 of the merchant system 20 continues, at block 626, the usual checkout process.

If insurance has been purchased, the insurance is added to the order and the premium of the policy is added to the total amount of the order. The merchant may also decide to pay for all or part of the premium and adjust the amount of the order accordingly. In an alternative embodiment, the next step of the checkout process may consist in providing information for the consumer to make the appropriate payment.

### Merchant Invoice Registration Process

The merchant invoice registration process is an alternative embodiment of the invoice registration process 300 shown in FIG. 4. In this embodiment, the merchant system 20 registers the invoice with the payment processor 30 on behalf of the consumer. The merchant system 20 transmits the invoice information directly to the payment processor 30 and then displays the PID to the consumer within the web browser 11 of the consumer communication device 10. In this embodiment the consumer communication device 10 does not communicate directly with the payment processor 30.

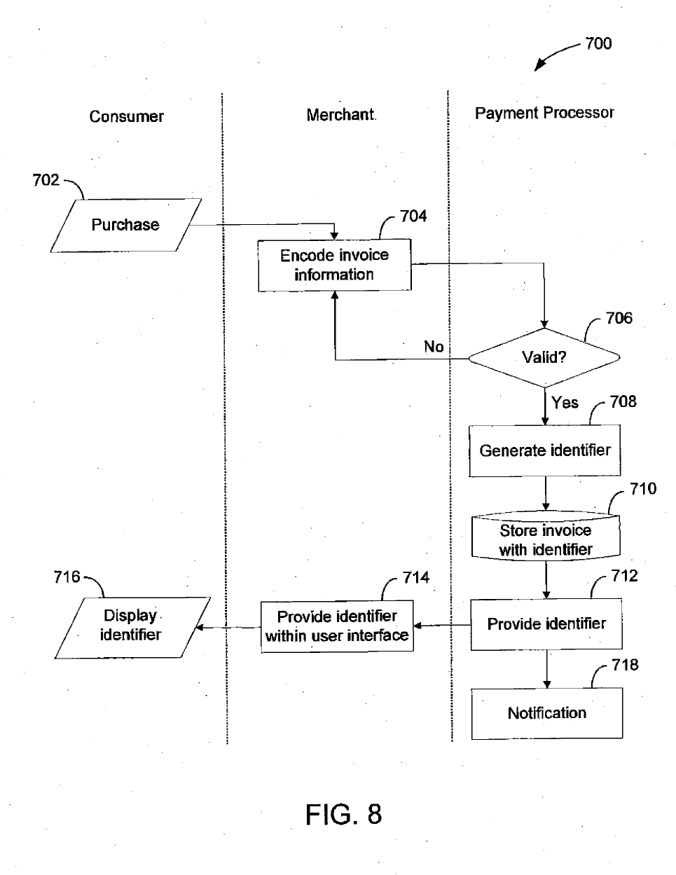

Referring to FIG. 8, there is shown a flow diagram of an illustrative example of the merchant invoice registration process 700. Steps of the process 700 are indicated by blocks 702 to 718.

The process 700 starts at block 702 where the consumer, using a communication device 10, accesses the merchant system 20 web server 22, browses the merchant's list of offered products or services and selects a product or service to purchase.

Then, at block 704, the invoice encoder 23 encodes the payment information (amount, currency, consumer details, etc.) and transmits the encoded information directly to the invoice registration program 38 of the payment processor 30. This may also include a merchant 20 authentication request from the payment processor web server 32.

At block 706, the invoice registration program 38 decodes the encoded invoice and validates the invoice information (e.g. the amount is positive, the currency is accepted, etc.). In some cases the invoice registration program 38 may also run fraud prevention algorithms to prevent abuses of the reverse payment processor system 30. If the invoice information is not valid, the process 700 returns to block 704 where the merchant system 20 is notified that there is a problem with the invoice and may prompt the merchant system 20 to resend the invoice or provide a new one.

If the invoice information is valid, the process 700 proceeds to block 708 where the PID is generated by the identifier generation program 31 and associated with the invoice. In some embodiment the PID can be unique for the lifetime of the system, in others, for a finite period of time such that the PID may be reused. A pseudo-random algorithm may be used to generate or select the identifier.

Then, at block 710, the invoice information along with the PID are stored in the payment processor database 40. The invoice is then marked as pending (i.e. not paid).

At block 712, the PID is provided to the merchant system 20, for example through a web service HTTP request/response, after which, at block 714, the merchant system 20 embeds the PID within its user interface to display, at block 716, the PID through the web browser 11 of the consumer communication device 10. As an example, the PID could by embedded within the HTML of a web page rendered by the web server 22 of the merchant system 20. The PID can then be copied/pasted, printed, or sent to an email box, a mobile phone, or otherwise recorded.

Finally, at block 718, the invoice registration program 38 may send further notification of the registered pending invoice (e.g. to the merchant system 20).

In alternative embodiments of the present invention, the consumer may open an account with the reverse payment processor system 30 and deposit money through point-of-payment devices 50 that can be used to acquit registered bills at a later time.

In another alternative embodiment, the consumer may enter the PID in its mobile phone, and pay with the phone (in regions where mobile phone payment is enabled).

In a further alternative embodiment, billing information may be encoded into code (2D barcode) such that it may be processed offline at the point-of-payment device 50.

Additional embodiments of the present invention also generally relate to systems and methods for facilitating transactions between a merchant-partner and a customer. For example, the present invention provides a merchant-partner with a means for conducting a cash transaction via a remote point-of-sale (POS) terminal The present invention is particularly useful in facilitating transactions such as: sale/purchase agreements, loan repayments, collections, money transfers, bill payments, remote deposits, etc.

The terms “merchant” and “merchant-partner” are used interchangeably herein. It is noted that the term “merchant” and/or “merchant-partner” is not limited to entities that directly sell goods/services. For example, a merchant may be a loan service, collections service, money transfer service, bill payment service, bank deposit service, credit union, etc. The terms “consumer,” “customer,” and “end-user” are used interchangeably herein. However, it is noted that the use of the systems and methods presented is not limited to sale/purchase transactions between a seller and a buyer. The systems and methods presented may be used to facilitate transactions between: two individuals, an individual and a business, two businesses, etc. The systems and methods presented may also be used to facilitate transactions between any two parties that have a pre-existing relationship or obligation(s). The terms “point-of-sale,” “point-of-sale terminal,” “POS,” “POS terminal,” and “point-of-payment” are used interchangeably herein. The terms “service provider” and “payment processor” are used interchangeably herein.

In one embodiment, a service provider and/or a POS terminal serves as an intermediary between a merchant and the customer. The system allows the customer to pay for the merchant's goods/services in cash (or cash equivalents) at a POS terminal The POS terminal and/or service provider then notifies the merchant that the customer has made a payment. After the merchant has received a notification, validation, or otherwise confirmation of payment, the merchant can securely deliver the agreed upon goods/services to the customer.

However, in order for such system to be commercially viable, the systems and methods presented generally include the process steps of: (a) staging a transaction between the merchant and the customer; (b) tokenizing the transaction by linking one or more transaction instructions to a token ID; (c) providing the customer with the token ID, wherein the customer can then present the token ID and a payment to a POS terminal; (d) receiving confirmation that the customer has presented, to a POS terminal, the token ID and a payment in accordance with the one or more transaction instructions; (e) notifying the merchant that the customer provided the payment to the POS terminal; and (f) settling the transaction between the POS terminal and the merchant.

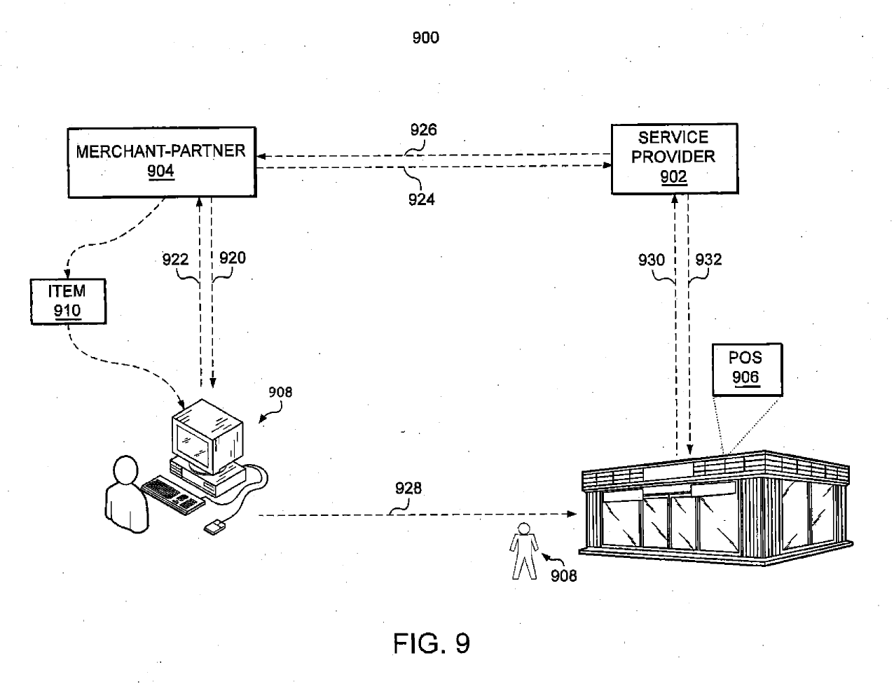

The following is a description of one or more embodiments of the present invention, with reference to FIGS. 9-16. It is to be understood that the present invention is not limited to the particular embodiments described. It is also to be understood that the terminology used herein is for the purpose of describing particular embodiments only, and is not intended to be limiting, since the scope of the present invention will be limited only by the appended claims.

FIG. 9 is a high-level flow process chart, illustrating the relationships between the parties that partake in the presented system 900. In general, system 900 includes four key parties: (1) service provider 902; (2) merchant-partner 904; (3) point-of-sale (POS) terminal 906; and (4) end-user 908. The dashed lines in FIG. 9 generally represent a flow of information, data, or process between respective parties. In practice, the dashed lines in FIG. 9 represent user interfaces and/or application program interfaces (APIs) for the transmission of information, data, instructions, funds, etc.

As will be described further below, service provider 902 and POS 906 play a central role in facilitating transactions between merchant-partner 904 and end-user 908. In one embodiment, each party serves a stand-alone function within system 900. However, in an alternative embodiment, service provider 902 may be incorporated into, or be a functional unit of, merchant-partner 904 and/or POS 906. Further, merchant-partner 904 may be any type of merchant, seller, or retailer; such as an online, web-based merchant, or catalog-based merchant. POS 906 may be a local retailer (e.g., relative to end-user 908), ATM, kiosk, or other cash-exchange terminal, intermediary, or equivalent thereof.

In FIG. 9, process flow 920 and 922 represents an exchange between merchant-partner 904 and end-user 908. In the example shown, merchant-partner 904 provides end-user 908 with a user-interface to purchase a goods/services. For example, the merchant may provide the user with a “checkout” experience over: a webpage on a merchant's website; an interface on a mobile device; an interactive voice system over a telephone network; or any interface equivalent thereto. While known customer user-interfaces may provide a “checkout” experience that allows an end-user to enter their credit card information, the system shown in FIG. 9 provides the end-user with a checkout experience that allows the end-user to pay for the goods/services in cash (or cash equivalents).

If the end-user selects to pay in cash, then merchant-partner 904 interfaces and exchanges information with service provider 902, as represented by process flow 924, 926. In practice, merchant-provider 904 and/or service provider 902 stages a transaction by linking a set of one or more transaction instructions to end-user 908. The transaction instructions may vary, but generally include instructions on what actions (e.g., payments) need to be performed by end-user 908 in order for merchant-partner 904 to provide end-user 908 with the agreed upon goods/services (e.g., item 910).

Service provider 902 then “tokenizes” the staged transaction by linking the set of one or more transaction instructions to a token ID. (The terms “token,” “token ID,” “unique payment identifier,” and “PID” are used interchangeably herein.) In an alternative embodiment, a single token ID can be linked to multiple staged transactions and/or multiple merchant-partners. The token ID is then provided to end-user 908. The token ID can be provided to the end-user 908 either directly from service provider 902, or via POS 906 or merchant-partner 904. When end-user 908 is ready to make a payment, end-user 908 presents the token ID to POS 906, along with an appropriate payment, as represented by process flow 928. At POS 906, the token ID serves as a means of linking the end-user's payment to the one or more transaction instructions.

The tokenizing of staged transactions, inter alia, facilitates integration between a merchant-partner's internal system and records, and a POS terminal system, without compromising security information for merchant-partner 904 and/or end-user 908. The tokenizing of the staged transaction also allows for a “standardization” of the process. As such, end-user 908 can use one or more token IDs to conduct transactions with one or more merchant-partners, and vice-versa.

When end-user 908 presents the token ID and payment to POS 906, the token ID is used to route the presentment information to service provider 902, as represented by process flow 930, 932. Service provider 902 may then validate that the presentment was in accordance with the transaction instructions linked to the token ID. If the end-user's payment is in accordance with the transaction instructions linked to the token ID, then service provider 902 notifies merchant-partner 904 that a payment has been made. Merchant-partner 904 then complete the transaction by, for example, shipping item 910 or otherwise fulfilling the transaction and/or crediting end-user's 908 account with merchant-partner 904. Service provider 902 then settles the transaction between merchant-partner 904 and POS 906 by receiving the payment funds (minus any agreed upon service fees) from POS 906, and delivering the payment funds (minus any agreed upon service fees) to merchant-partner 904.

In an alternative embodiment, the systems and methods described herein do not require merchant-partner 904 to provide end-user 908 with a checkout experience. There is also no requirement that the end-user provide an intent or selection of a cash payment option. For example, in one embodiment, merchant-partner 904 provides its customers with one or more tokens as a means for the customers to make payments. The payments can be made at a POS terminal, and a series of staged transactions may proceed, without any front-end involvement by the end-user.

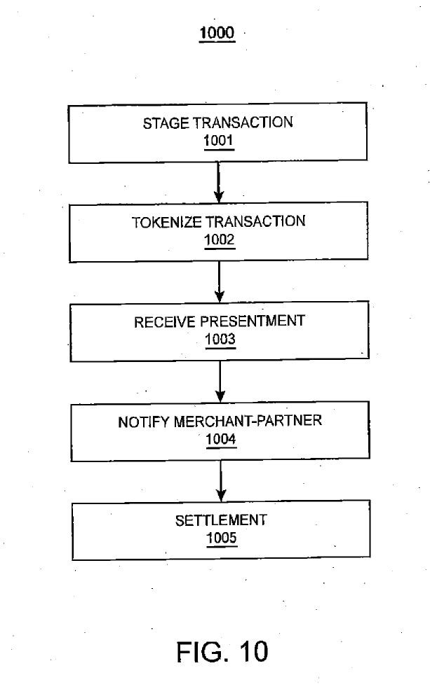

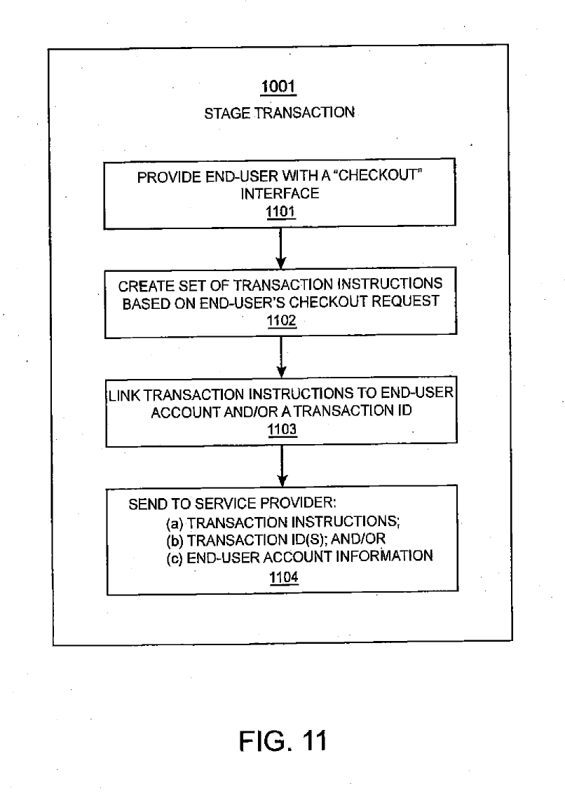

FIG. 10 is a high-level flowchart illustrating a method 1000 for facilitating a transaction between a merchant and a customer, in accordance with one embodiment presented herein. More specifically, FIG. 10 is a flowchart generally illustrating the steps performed in the system described in FIG. 9. The method includes: (a) staging a transaction (step 1001); (b) tokenizing the staged transaction (step 1002); (c) receiving the presentment (step 1003); (d) notifying the merchant-partner that the presentment has been received (step 1004); and (e) settling the transaction between the parties (step 1005). Additional details for steps (a)-(e) are provided below with reference to FIGS. 11-15.

For example, FIG. 11 is a flowchart illustrating the steps taken when staging a transaction 1001 between a merchant-partner 904 and an end-user 908, in accordance with one embodiment presented herein. First, in the embodiment shown, the end-user is provided with a “checkout” interface, in step 1101. As discussed above, the checkout interface may include: a webpage on a merchant's website; an interface on a mobile device; an interactive voice system over a telephone network; or any interface equivalent thereto. In step 1102, a set of transaction instructions are created based on the end-user's checkout request. For example, the transaction instructions may include information such as: the goods/services desired; the payment amount; the time of expiration of the transaction; the POS terminal that will be used; etc. In step 1103, the transaction instructions are linked to an end-user's account with the merchant, or to a transaction ID maintained by the merchant. In step 1104, information relevant to the staged transaction (or transaction instructions) is sent to the service provider. For example, in one embodiment, the service provider is sent: transaction instructions; merchant transaction IDs; and/or the end-user's merchant account information.

In alternative embodiments, staging of a transaction may be performed by various ways/means. For example, an end-user does not need to be provided with a “checkout” interface. The transaction may be staged without any end-user input. Further, staging may occur by the merchant-partner and/or the end-user accessing the service providers system to enter the appropriate information.

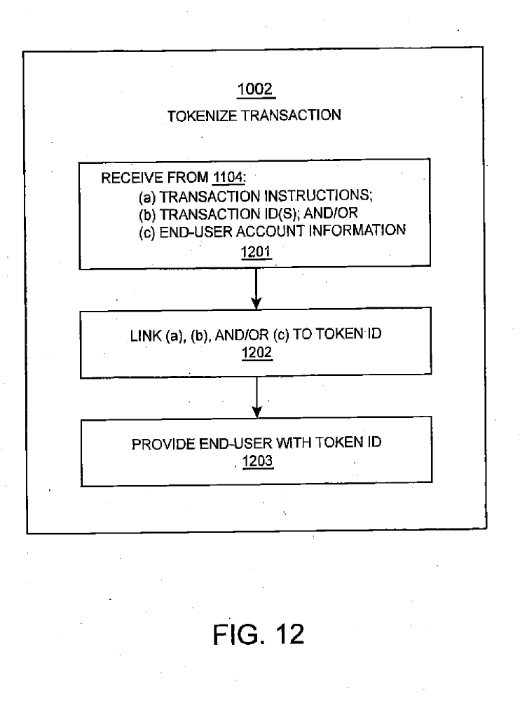

FIG. 12 is a flowchart illustrating the steps taken when tokenizing a transaction 1002, in accordance with one embodiment presented herein. In step 1201, the service provider receives from step 1104 the staged transaction and/or information such as: transaction instructions; merchant transaction IDs; and/or the end-user's merchant account information. In an alternative embodiment, the service provider may receive from the merchant a staged transaction in the form of a standardized data file or database with the requisite information. In step 1202, the transaction instructions, merchant transaction IDs, and/or the end-user's merchant account information is linked to a token ID. In step 1203, the token ID is provided to the end-user. As described above, the token ID may be provided to the user directly from the service provider, or indirectly through the merchant or POS terminal. The token ID may be provided in a form such as: a printout slip, a transaction card, a printed barcode, a pin number, a near-field communication chip, a mobile device prompt, a mobile device barcode, and any combination or equivalent thereof. The token may also be a physical item that the end-user can pick up at a POS terminal or other retail location.

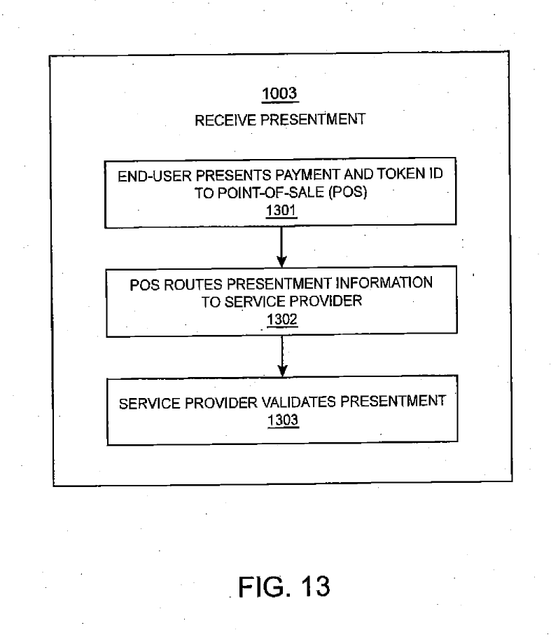

FIG. 13 is a flowchart illustrating the steps taken to receive the presentment from the end-user, in accordance with one embodiment. In step 1301, the end-user presents payment and the token ID to the POS terminal. The token ID is preferably configured to seamlessly integrate with the POS terminal's cash-exchange system. As such, a clerk or employee at the POS terminal can receive the presentment as a transaction typical to the POS terminal (i.e., without any specialized instructions, training, equipment, etc.). For example, in one embodiment, the token ID is a barcode that can be presented to a barcode scanner at the POS terminal. The token ID may include routing information such that the POS terminal automatically communicates and routes the presentment information to the service provider, as in step 1302. In step 1303, the service provider receives and validates the presentment information. For example, the service provider can confirm whether the end-user has acted in accordance with the transaction instructions (e.g., paid the appropriate amount; made payment prior to expiration of the transaction; etc.). The service provider may also take additional steps to validate the presentment; such as, communicating with the merchant to ensure the staged transaction is still valid, confirming the merchant still has the inventory/resources to provide the goods/services, confirming that the payment amount is still acceptable to merchant, etc.

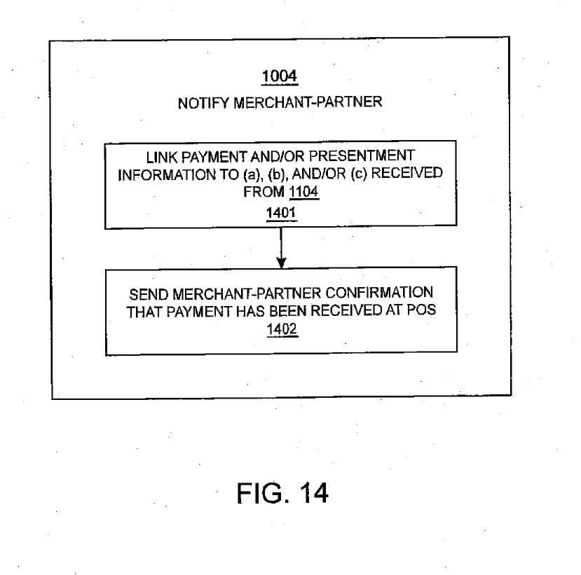

FIG. 14 is a flowchart illustrating the steps taken to notify the merchant that the presentment has been made and validated 1004, in accordance with one embodiment presented herein. In step 1401, the service provider links the payment and/or presentment information to the transaction instructions, merchant transaction IDs, and/or the end-user's merchant account information received in step 1104. In step 1402, the service provider sends the merchant-partner confirmation that a payment from the end-user has been received at the POS terminal. Notification may occur through various ways/means. For example, notification may occur by an API call/link, e-mail, text message, or equivalents thereof. Notification may also include a communication asking the merchant-partner if the transaction is still valid (e.g., the transaction has not expired; there is sufficient inventory to complete the transaction; the payment amount(s) is still satisfactory; the merchant-partner still wants to complete the transaction(s)). Notification may also include a communication with the POS and/or end-user to reconfirm the merchant-partner's validation of the transaction.

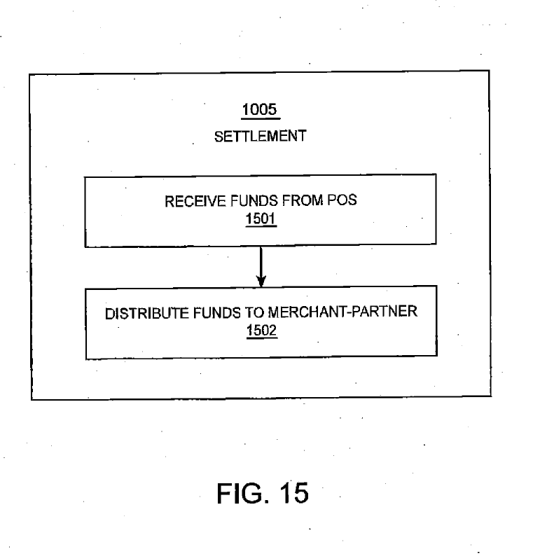

FIG. 15 is a flowchart illustrating the steps of settling the transaction 1005 between the various parties, in accordance with one embodiment. In step 1501, the service provider receives funds from the POS terminal. In step 1502, the service provider distributes funds to the merchant-partner. In an alternative embodiment, the steps may be reversed in order to meet the settlement requirements of the various parties. The timing of the performance of steps 1501 and 1502 can also be modified in accordance with the settlement requirements of the various parties. Further, the service provider may adjust the amounts received and/or distributed in accordance with a contractual agreement between the parties. As used herein the phrases “receive funds from POS terminal” and “distribute funds to the merchant-partner” do not require direct communications/transfers between individual entities. Settlement also does not require the actual “touching” of funds. For example, as used herein, to “settle the transaction between the point-of-sale terminal and the merchant-partner” means to: transfer funds; direct funds; provide an interface for the transfer of funds; and/or otherwise provide the necessary instructions to make sure the funds are properly directed from one entity to another. Further, to “settle the transaction between the point-of-sale terminal and the merchant-partner” includes communications/transfer with any and all centralized or hierarchical entities that receive funds from individual points-of-sale at the closing a banking day.

It is noted that the figures (e.g., FIGS. 11-15), individually and/or collectively, serve as embodiments of the presented systems and methods. Each individual process or sub-process performed within the embodiments described can be performed by one or more parties, as well as one or more computer systems. For example, in one embodiment, some or all of the communications and data transfers between merchant, service provider, and POS terminal are performed via an automated computer-based system, such as an application program interface. Further, not all of the individual process or sub-process described are necessary for implementing the systems and methods described herein. As such, the embodiments presented in the figures (e.g., FIGS. 11-15) are not intended to be limiting.

In another embodiment, there is provided a method comprising: (a) receiving a staged transaction from a merchant-partner, wherein the staged transaction links one or more transaction instructions to an end-user; (b) tokenizing the staged transaction by linking the staged transaction to a token ID; (c) providing the end-user with the token ID; (d) receiving confirmation that the end-user has presented, to a point-of-sale terminal, the token ID and a payment in accordance with the one or more transaction instructions; (e) notifying a merchant-partner that the end-user has provided the payment to the point-of-sale terminal; and (f) settling the staged transaction between the point-of-sale terminal and the merchant-partner. In one embodiment, the token ID is provided to the end-user via the merchant-partner. In one embodiment the token ID is provided to the end-user in a form selected from the group consisting of: a printout slip, a transaction card, a printed barcode, a pin number, a near-field communication chip, a mobile device prompt, a mobile device barcode, and any combination thereof. The method may further comprise providing the point-of-sale terminal with an application program interface such that the point-of-sale terminal can confirm that the end-user has presented the token ID and provided the payment to the point-of-sale terminal. In one embodiment, prior to step (e), the method further comprises contacting the merchant-partner to confirm the validity of the transaction.

In yet another embodiment, there is provided a computer-based system, comprising: (a) means for staging a transaction between a merchant and an end-user; (b) means for tokenizing the staged transaction; (c) means for providing the end-user with the tokenized transaction; (d) means for receiving confirmation that the end-user has presented, to a point-of-sale terminal, a token ID and a payment in accordance with the staged transaction; (e) means for notifying a merchant-partner that the end-user provided the payment to the point-of-sale terminal; and (f) means for settling the transaction between the point-of-sale terminal and the merchant-partner. In various embodiments, the “means for” performing said functions may include programmable or customizable user-interfaces and APIs to perform the receipt, organization, and transfer of information, data, instructions, etc.

In still another embodiment, there is provided a method of facilitating a transaction, the method comprising: (a) tokenizing a transaction by linking one or more transaction instructions a token ID; (b) providing an end-user with the token ID; (c) receiving confirmation that the end-user has presented, to a point-of-sale terminal, the token ID and a payment in accordance with the one or more transaction instructions; and (d) notifying a merchant-partner that the end-user has provided the payment to the point-of-sale terminal. The method may further comprise: (1) settling the transaction between the point-of-sale terminal and the merchant-partner; (2) contacting the merchant-partner to confirm the validity of the staged transaction; and/or (3) contacting the point-of-sale terminal to reconfirm the validity of the staged transaction.

According to an illustrative embodiment of the present invention, there is provided a reverse payment transaction system and method for allowing a consumer to make an online purchase from a merchant without providing financial details. The method comprises the steps of:

a. providing a payment identifier associated with the purchase to the consumer;

b. receiving at a point-of-sale the payment identifier from the consumer;

c. providing the payment identifier from the point-of-sale to a payment processor;

d. receiving the invoice at the point-of-sale from the payment processor;

e. receiving payment from the consumer at the point-of sale;

f. indicating to the payment processor that payment of the invoice was made;

g. generating on the payment processor a receipt; and

h. providing the receipt to the point-of-sale.

According to another illustrative embodiment of the present invention, the step of providing the unique payment identifier to the consumer further comprises the sub-steps of:

a1. generating an invoice associated with the purchase;

a2. encoding the invoice;

a3. providing the encoded invoice to a payment processor;

a4. decoding on the payment processor the encoded invoice;

a5. generating on the payment processor a payment identifier associated with the invoice;

a6. storing the invoice and associated payment identifier in a payment processor database; and

a7. providing the payment identifier to the consumer.

### Computer Implementation.

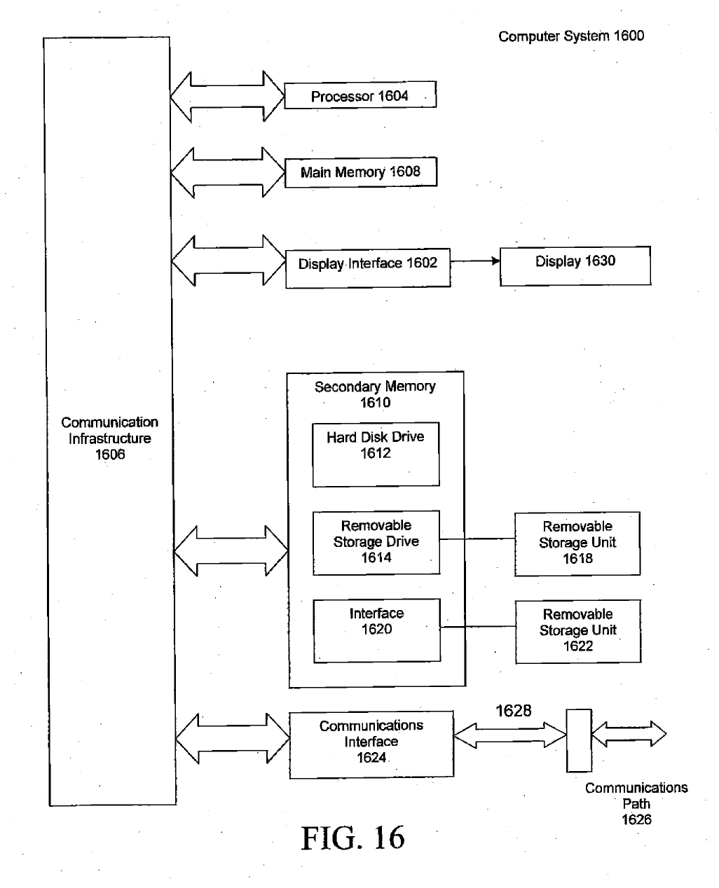

In one embodiment, the invention is directed toward one or more computer systems capable of carrying out the functionality described herein. For example, FIG. 16 is a schematic drawing of a computer system 1600 used to implement the methods presented above. Computer system 1600 includes one or more processors, such as processor 1604. The processor 1604 is connected to a communication infrastructure 1606 (e.g., a communications bus, cross-over bar, or network). Computer system 1600 can include a display interface 1602 that forwards graphics, text, and other data from the communication infrastructure 1606 (or from a frame buffer not shown) for display on a local or remote display unit 1630.

Computer system 1600 also includes a main memory 1608, such as random access memory (RAM), and may also include a secondary memory 1610. The secondary memory 1610 may include, for example, a hard disk drive 1612 and/or a removable storage drive 1614, representing a floppy disk drive, a magnetic tape drive, an optical disk drive, flash memory device, etc. The removable storage drive 1614 reads from and/or writes to a removable storage unit 1618. Removable storage unit 1618 represents a floppy disk, magnetic tape, optical disk, flash memory device, etc., which is read by and written to by removable storage drive 1614. As will be appreciated, the removable storage unit 1618 includes a computer usable storage medium having stored therein computer software, instructions, and/or data.

In alternative embodiments, secondary memory 1610 may include other similar devices for allowing computer programs or other instructions to be loaded into computer system 1600. Such devices may include, for example, a removable storage unit 1622 and an interface 1620. Examples of such may include a program cartridge and cartridge interface (such as that found in video game devices), a removable memory chip (such as an erasable programmable read only memory (EPROM), or programmable read only memory (PROM)) and associated socket, and other removable storage units 1622 and interfaces 1620, which allow computer software, instructions, and/or data to be transferred from the removable storage unit 1622 to computer system 1600.

Computer system 1600 may also include a communications interface 1624. Communications interface 1624 allows computer software, instructions, and/or data to be transferred between computer system 1600 and external devices. Examples of communications interface 1624 may include a modem, a network interface (such as an Ethernet card), a communications port, a Personal Computer Memory Card International Association (PCMCIA) slot and card, etc. Software and data transferred via communications interface 1624 are in the form of signals 1628 which may be electronic, electromagnetic, optical or other signals capable of being received by communications interface 1624. These signals 1628 are provided to communications interface 1624 via a communications path (e.g., channel) 1626. This channel 1626 carries signals 1628 and may be implemented using wire or cable, fiber optics, a telephone line, a cellular link, a radio frequency (RF) link, a wireless communication link, and other communications channels.

In this document, the terms “computer-readable storage medium,” “computer program medium,” and “computer usable medium” are used to generally refer to media such as removable storage drive 1614, removable storage units 1618, 1622, data transmitted via communications interface 1624, and/or a hard disk installed in hard disk drive 1612. These computer program products provide computer software, instructions, and/or data to computer system 1600. These computer program products also serve to transform a general purpose computer into a special purpose computer programmed to perform particular functions, pursuant to instructions from the computer program products/software. Embodiments of the present invention are directed to such computer program products.

Computer programs (also referred to as computer control logic) are stored in main memory 1608 and/or secondary memory 1610. Computer programs may also be received via communications interface 1624. Such computer programs, when executed, enable the computer system 1600 to perform the features of the present invention, as discussed herein. In particular, the computer programs, when executed, enable the processor 1604 to perform the features of the presented methods. Accordingly, such computer programs represent controllers of the computer system 1600. Where appropriate, the processor 1604, associated components, and equivalent systems and sub-systems thus serve as “means for” performing selected operations and functions. Such “means for” performing selected operations and functions also serve to transform a general purpose computer into a special purpose computer programmed to perform said selected operations and functions.

In an embodiment where the invention is implemented using software, the software may be stored in a computer program product and loaded into computer system 1600 using removable storage drive 1614, interface 1620, hard drive 1612, or communications interface 1624. The control logic (software), when executed by the processor 1604, causes the processor 1604 to perform the functions and methods described herein.

In another embodiment, the methods are implemented primarily in hardware using, for example, hardware components such as application specific integrated circuits (ASICs) Implementation of the hardware state machine so as to perform the functions and methods described herein will be apparent to persons skilled in the relevant art(s). In yet another embodiment, the methods are implemented using a combination of both hardware and software.

Embodiments of the invention may also be implemented as instructions stored on a machine-readable medium, which may be read and executed by one or more processors. A machine-readable medium may include any mechanism for storing or transmitting information in a form readable by a machine (e.g., a computing device). For example, a machine-readable medium may include read only memory (ROM); random access memory (RAM); magnetic disk storage media; optical storage media; flash memory devices; electrical, optical, acoustical or other forms of propagated signals (e.g., carrier waves, infrared signals, digital signals, etc.), and others. Further, firmware, software, routines, instructions may be described herein as performing certain actions. However, it should be appreciated that such descriptions are merely for convenience and that such actions in fact result from computing devices, processors, controllers, or other devices executing firmware, software, routines, instructions, etc.

For example, in one embodiment, there is provided a computer-readable storage medium, having instructions executable by at least one processing device that, when executed, cause the processing device to: (a) tokenize a staged transaction by linking one or more transaction instructions to a token ID; (b) provide an end-user with the token ID; (c) receive confirmation that the end-user has presented, to a point-of-sale terminal, the token ID and a payment in accordance with the one or more transaction instructions; (d) notify a merchant-partner that the end-user has provided the payment to the point-of-sale terminal; and (e) settle the transaction between the point-of-sale terminal and the merchant-partner. The computer-readable storage medium may further include instructions executable by at least one processing device that, when executed, cause the processing device to: (1) prepare the staged transaction by linking the one or more transaction instructions to the end-user; (2) provide the end-user with a checkout interface; (3) prepare the token ID in a form selected from the group consisting of: a printout slip, a transaction card, a printed barcode, a pin number, a near-field communication chip, a mobile device prompt, a mobile device barcode, and any combination or equivalent thereof; (4) link the one or more transaction instructions to an end-user account maintained by the merchant-partner; (5) link the one or more transaction instructions to a merchant-partner transaction ID; (6) link the token ID to the merchant-partner transaction ID; and/or (7) interface with the point-of-sale terminal in order to receive confirmation that the end-user presented the token ID and provided the payment to the point-of-sale terminal

### CONCLUSION

The foregoing description of the invention has been presented for purposes of illustration and description. It is not intended to be exhaustive or to limit the invention to the precise form disclosed. Other modifications and variations may be possible in light of the above teachings. The embodiments were chosen and described in order to best explain the principles of the invention and its practical application, and to thereby enable others skilled in the art to best utilize the invention in various embodiments and various modifications as are suited to the particular use contemplated. It is intended that the appended claims be construed to include other alternative embodiments of the invention; including equivalent structures, components, methods, and means.

Unless defined otherwise, all technical and scientific terms used herein have the same meaning as commonly understood by one of ordinary skill in the art to which this invention belongs.

As will be apparent to those of skill in the art upon reading this disclosure, each of the individual embodiments described and illustrated herein has discrete components and features which may be readily separated from or combined with the features of any of the other several embodiments without departing from the scope or spirit of the present invention. Any recited method can be carried out in the order of events recited or in any other order which is logically possible.

It is to be appreciated that the Detailed Description section, and not the Summary and Abstract sections, is intended to be used to interpret the claims. The Summary and Abstract sections may set forth one or more, but not all exemplary embodiments of the present invention as contemplated by the inventor(s), and thus, are not intended to limit the present invention and the appended claims in any way.

What is claimed is:

1. A computer-implemented method for facilitating a transaction between a merchant-partner and an end-user, the method comprising:
(a) staging a transaction on a database by creating a database entry linking one or more transaction instructions to an end-user;
(b) tokenizing the transaction by linking the database entry to a token ID;
(c) providing the end-user with the token ID, wherein the token ID is provided to the end-user in a form selected from the group consisting of: a printout slip, a transaction card, a printed barcode, a pin number, a near-field communication chip, a mobile device prompt, a mobile device barcode, and any combination thereof;
(d) providing a point-of-sale terminal with an application program interface such that the point-of-sale terminal can confirm that the end-user has presented the token ID and provided a payment to the point-of-sale terminal.
(e) receiving confirmation that the end-user has presented, to a point-of-sale terminal, the token ID and the payment;
(f) verifying whether the payment is in accordance with the one or more transaction instructions; and
(g) notifying a merchant-partner that the end-user provided the payment.

2. The method of claim 1, further comprising:
settling the transaction between the point-of-sale terminal and the merchant-partner.

3. The method of claim 1, further comprising:
contacting the merchant-partner to confirm the validity of the staged transaction.

4. The method of claim 3, further comprising:
contacting the point-of-sale terminal to reconfirm the validity of the staged transaction.

5. A computer-implemented method for facilitating a transaction between a merchant-partner and an end-user, the method comprising:
(a) staging a transaction on a database by creating a database entry linking one or more transaction instructions to an end-user;
(b) tokenizing the transaction by linking the database entry to a token ID;
(c) providing the end-user with the token ID;
(d) receiving confirmation that the end-user has presented, to a point-of-sale terminal, the token ID and a payment;
(e) verifying whether the payment is in accordance with the one or more transaction instructions; and
(f) notifying a merchant-partner that the end-user provided the payment.

6. The method of claim 5, wherein step (a) further comprises:
providing the end-user with a checkout interface.

7. The method of claim 5, wherein step (a) further comprises:
linking the database entry to an end-user account maintained by the merchant-partner.

8. The method of claim 5, wherein step (a) further comprises:
linking the database entry to a merchant-partner transaction ID.

9. The method of claim 8, wherein step (b) further comprises:
linking the token ID to the merchant-partner transaction ID.

10. The method of claim 5, wherein the token ID is provided to the end-user via the merchant-partner.

11. The method of claim 5, wherein the token ID is provided to the end-user via the point-of-sale terminal.

12. The method of claim 5, wherein the token ID is provided to the end-user in a form selected from the group consisting of: a printout slip, a transaction card, a printed barcode, a pin number, a near-field communication chip, a mobile device prompt, a mobile device barcode, and any combination thereof.

13. The method of claim 5, wherein step (d) further comprises:
providing the point-of-sale terminal with an application program interface such that the point-of-sale terminal can confirm that the end-user has presented the token ID and provided the payment to the point-of-sale terminal.

14. The method of claim 5, further comprising:
settling the transaction between the point-of-sale terminal and the merchant-partner.

15. The method of claim 5, further comprising:
contacting the merchant-partner to confirm the validity of the staged transaction.

16. The method of claim 15, further comprising:
contacting the point-of-sale terminal to reconfirm the validity of the staged transaction.

17. A computer-readable storage medium, comprising:
instructions executable by at least one processing device that, when executed, cause the processing device to
(a) stage a transaction on a database by creating a database entry linking one or more transaction instructions to an end-user;
(b) tokenize the transaction by linking the database entry to a token ID;
(c) provide the end-user with the token ID;
(d) receive confirmation that the end-user has presented, to a point-of-sale terminal, the token ID and a payment;
(e) verify whether the payment is in accordance with the one or more transaction instructions; and
(f) notify a merchant-partner that the end-user provided the payment.

18. The computer-readable storage medium of claim 17, further comprising:
instructions executable by at least one processing device that, when executed, cause the processing device to settle the transaction between the point-of-sale terminal and the merchant-partner.

19. The computer-readable storage medium of claim 17, further comprising:
instructions executable by at least one processing device that, when executed, cause the processing device to contact the merchant-partner to confirm the validity of the staged transaction.

20. The computer-readable storage medium of claim 19, further comprising:
instructions executable by at least one processing device that, when executed, cause the processing device to contact the point-of-sale terminal to reconfirm the validity of the staged transaction.
